(19) United States
(12) Patent Application Publication
(10) Pub. No.: US 2009/0106076 A1
(43) Pub. Date: Apr. 23, 2009

(54) System and method for a time sensitive scheduling data promotions network

(75) Inventor: Robert Bernard Coley, Palo Alto, CA (US)

Correspondence Address: DAVID LEWIS, 1250 AVIATION AVE., SUITE 200B, SAN JOSE, CA, 95110, US

(73) Assignee: Keep In Touch SystemsTM, Inc.

(21) Appl. No.: 12/288,236

(22) Filed: Oct. 17, 2008

Related U.S. Application Data
(60) Provisional application No. 60/981,360, filed on Oct. 19, 2007.

(51) Int. Cl. G05B 19/00; G06Q 30/00; G06Q 90/00

(52) U.S. Cl. 705/8; 705/14

(57) ABSTRACT

Communications network based passive delivery of relevant and desired promotional content and time sensitive scheduling data to an entity is described. Promotional content is targeted based on targeting criteria. Promotional content based on the targeting criteria is distributed via the passive delivery communications network. Promotional content aggregated as part of time sensitive scheduling data streams is delivered via the passive delivery communications network. The passive delivery of promotional content in proximity to the relevant time sensitive scheduling data is presented to the entity via a time sensitive scheduling data receiving device.

### CROSS-REFERENCE TO RELATED APPLICATIONS

This application claims priority benefit of U.S. Provisional Patent Application No. 60/981,360, entitled, “SYSTEM AND METHOD FOR A TIME SENSITIVE SCHEDULING DATA PROMOTIONS NETWORK,” by Robert Bernard Coley, filed Oct. 19, 2007, which is incorporated herein by reference in its entirety.

### BACKGROUND OF THE INVENTION

1. Field of the Invention

This invention relates generally to targeted promotional content and more particularly to the receiving and transmitting of specific promotional content packaged with and related to time sensitive scheduling data delivered to an entity.

2. Description of the Related Art

The advertising relevancy model followed by major search engine firms relies on exploiting the efforts that people expend on searching for information published on the Internet or intranets. That is locating targeted information via matching keywords (a.k.a., search terms) appearing in the text, index of the targeted content, or meta data published with the targeted information. Other advertising relevancy models incorporate schemes for determining which sites an internet user has previously visited to derive an “interest” level for determining advertising relevancy. Most people spend 95 per cent of their time on the Internet doing things other than searching. They read news and entertainment sites, send e-mail or instant messages, blog or display photographs. When people do search, many searches are very broad and are not connected to buying something advertised on the Internet. In other forms of media (e.g., television, radio, and newspapers) advertising rates are based on TV ratings and magazine circulation. Publishers and broadcasters gain advertising by offering the chance to reach potential customers, clients or partners in a block. On the Internet it is hard to find websites with enough traffic to attract large blocks of advertising. Some search engine companies have achieved substantial revenues from their ability to attract large audiences. However, their strength in this area could become a vulnerability, if other websites and publishers find a way to remedy this imbalance by providing mechanism to more effectively target client advertisements.

One method of doing so, that is, attracting interest among advertisers and publishers is an advertising methodology called behavioral targeting. Behavioral targeting involves an Internet user being shown advertisements that are likely to interest them, no matter which site they happen to be browsing at the time. This is accomplished by using a cookie, a small data file that sits on users' computers to assist in tracking their behavior. In behavioral targeting, the advertisements are shown to users based on the subject matter or type of websites they visit and/or what the user does on those websites.

However, certain concerns have arisen concerning the effectiveness of behavioral targeting. Two primary concerns are (1) since behavioral targeting is a recent development it could fail due to privacy concerns; and (2) the inability of many diverse websites to work together. Another concern is that existing internet methods of behavioral targeting do not guarantee creating an audience for a message where none had been there before. It has been found that existing internet behavioral targeting methods appear to work better on less targeted ad inventory. Advertisers who have purchased targeted ad inventory are already more likely to generate strong responses, and therefore, behavioral targeting may make less of an impact. This puts into question the promise of the existing internet behavioral targeting methods to improve media efficiency and to identify those with a higher propensity to buy. In the field of internet based behavioral targeting, there are not yet clear understandings about what inferences can properly or accurately be drawn from demonstrated behavior. Other than the individual who clicks through to a completed sale, most internet based behavioral targeting at this point is guess work.

### SUMMARY OF THE INVENTION

The present disclosure accommodates the delivery of relevant and desired promotional content and time sensitive scheduling data via a communications network based primarily on affiliations between the time sensitive scheduling data provider and the consumer of the time sensitive scheduling data.

In one embodiment of the invention, communications network based passive delivery of relevant and desired promotional content and time sensitive scheduling data to an entity comprises targeting promotional content based on targeting criteria, distributing via a passive delivery communications network promotional content based on the targeting criteria, delivering via the passive delivery communications network promotional content aggregated as part of time sensitive scheduling data streams, and presenting the passive delivery of promotional content in proximity to the relevant time sensitive scheduling data to the entity via a time sensitive scheduling data receiving device. The targeted criteria are affiliations between targeted entities, an entity's activities, an entity's derived and designated interest in specific categories of time sensitive scheduling data, an entity's request for specific time sensitive scheduling data, and an entity's affiliation profile.

In another embodiment of the invention, the time sensitive scheduling data as described above consists of data relating to the class of entity activities selected from the group consisting of attending, timely participating, scheduling, planning, organizing, timely responding and reserving and a combination thereof. The class of entity activities originates from the class of time sensitive scheduling data activity sources selected from the group consisting of standard events, standard meetings, ad hoc activities, observances, and a combination thereof.

In another embodiment of the invention, the passive delivery of time sensitive scheduling data may include deriving interest for targeting a receiving entity based on information from provider organization's membership rolls and affiliation rolls as they pertain to entity affiliation items selected from the group consisting of entity-to-organization affiliations, entity-to-group affiliations, entity-to-individual affiliations, attributes from the organization's profile of the entity, and a combination thereof.

In another embodiment of the invention, the passive delivery of time sensitive scheduling data may include deriving interest for targeting a receiving entity wherein the derived interest is selected from the group consisting of the entity's filtering of time sensitive scheduling data, the entity's selection of promotional content accompanying the display of time sensitive scheduling data, the entity's tagging certain time sensitive scheduling data items for reminder notices of upcoming activities and observances, the entity's reservations notices for upcoming activities, the entity's need to know, and the entity's affinity groups.

In another embodiment, a system for communications network based passive delivery of relevant and desired promotional content and time sensitive scheduling data via a communication technology via a time sensitive scheduling data receiving device to an entity is described. The system may include a time sensitive scheduling data center for storing time sensitive scheduling data, collecting time sensitive scheduling data from an entity, and sending promotional content and time sensitive scheduling data to the entity upon the entity being authenticated and validated, connectivity medium communication interfaces for transmitting authentication, validation information, promotional content, and time sensitive scheduling data between the time sensitive scheduling data center, a communication technology, and a time sensitive scheduling data receiving device, and a communication technology suitable for receiving and sending the passive delivery of promotional content and time sensitive scheduling data. The system may also include processors for processing executable instructions for targeting promotional content based on targeting criteria, distributing via a passive delivery communications network promotional content based on the targeting criteria, delivering via the passive delivery communications network promotional content aggregated as part of time sensitive scheduling data streams, and presenting passive delivery of promotional content in proximity to relevant time sensitive scheduling data to the entity via a time sensitive scheduling data receiving device. Finally, the system may also include a time sensitive scheduling data receiving device for receiving and sending authentication, validation information, promotional content, and time sensitive scheduling data to the time sensitive scheduling data center via the connectivity medium communication interfaces via the communication technology.

In another embodiment of the invention, a receiving device suitable for providing the communications network based passive delivery of relevant and desired promotional content and time sensitive scheduling data to an entity is described. The device may include a display for displaying a message in accordance with promotional content and time sensitive scheduling data, a time sensitive scheduling data communication interface arranged to send and receive signals from servers of a time sensitive scheduling data network, a processor for processing executable authentication and validation instructions, and a controller in communication with the processor and the time sensitive scheduling data communication interface arranged to send and receive signals from the servers of the time sensitive scheduling data network to determine if a time sensitive scheduling data receiving entity is authenticated and validated to receive promotional content and time sensitive scheduling data from server wherein when the controller determines that the time sensitive scheduling data receiving entity is authenticated and validated to receive promotional content and time sensitive scheduling data from the server, then the processor notifies the server to send promotional content and time sensitive scheduling data to the receiving entity via the time sensitive scheduling data communication interface.

Another embodiment provides a computer program product executable by a computer processor for processing the passive delivery of relevant and desired promotional content and time sensitive scheduling data generated via a communications network to an entity. The computer program may include computer code for targeting promotional content based on targeting criteria, computer code for distributing via a passive delivery communications network promotional content based on the targeting criteria, computer code for delivering via the passive delivery communications network promotional content aggregated as part of time sensitive scheduling data streams, computer code for presenting the passive delivery of promotional content in proximity to the relevant time sensitive scheduling data to the entity via a time sensitive scheduling data receiving device, and computer readable medium for storing the computer code.

In another embodiment, a system for simultaneous passive delivery of relevant and desired promotional content and time sensitive scheduling data via multiple communication technologies via an array of multiple communication time sensitive scheduling data receiving devices to an entity is described. The system may include a time sensitive scheduling data center for storing time sensitive scheduling data, collecting time sensitive scheduling data from an entity, and sending promotional content and time sensitive scheduling data to the entity upon the entity being authenticated and validated, connectivity medium communication interfaces for transmitting authentication, validation information, promotional content, and time sensitive scheduling data between the time sensitive scheduling data center, multiple communication technologies, and multiple communication time sensitive scheduling data receiving devices, multiple communication technologies suitable for sending and receiving the passive delivery of promotional content and time sensitive scheduling data, processors for processing executable instructions, and multiple communication time sensitive scheduling data receiving devices for sending and receiving authentication, validation information, promotional content, and time sensitive scheduling data to the time sensitive scheduling data center via the connectivity medium communication interfaces via multiple communication technologies.

In another embodiment, an activity content delivery system is described. The activity content delivery system may include a system authorization process device performing entity validation checks and verification functions for requesting a entity's subscriber profile, a retrieve subscriber's profile process device extracting the entity's subscriber profile from a subscription profile database, a content fulfillment process device using information from the entity's subscribers profile to generate an activity retrieval request in the form of activity extraction criteria and a promotional content matching criteria from an affiliation profile criteria, an activity request process device extracting matching activity content from an activity content database, a promotional matching process device generating a promotion matching criteria by adding contextual information to the promotional content retrieval request, a promotional content retrieval process device extracting matching promotional content from a promotional content table, a content packaging process device generating bundles of content from processes involved in the matching promotional content fulfillment process, a data store, and time sensitive scheduling data receiving devices. The affiliation profile criteria is selected from the group consisting of a entity's affiliations, affinity groups, areas of interest for activities, areas of interest for associations, and a combination thereof. The contextual information is selected from the group consisting of time of day, entity language requirements, and entity location. The bundles of content are selected from the group consisting of activity content, matching promotional content, and administrative messages.

In another embodiment, a system for the passive delivery of aggregated promotional content and personal time sensitive scheduling data from multiple sources is described. The system may include promotional content and specific personal time sensitive scheduling data aggregated from multiple originating organizations, affiliated groups of individuals, and individuals to an entity based on desirability and relevancy of high utility time sensitive scheduling data, aggregated promotional content and specific personal time sensitive scheduling data streams transmitting to the entity based on the promotional content and the time sensitive scheduling data having desirability and relevancy of high utility, and promotional content and specific personal time sensitive scheduling data delivered to a time sensitive scheduling data receiving device.

### BRIEF DESCRIPTION OF THE DRAWINGS

Detailed and specific features of the present invention are more fully disclosed in the following sections, with reference being made to the accompanying drawings, in which:

FIG. 1 is a simplified system diagram of a promotional content and time sensitive scheduling data delivery network according to one embodiment of the invention.

FIG. 2 is a representation of a promotions network based on affiliation created by the receiving devices in the time sensitive scheduling data delivery network according to one embodiment of the invention.

FIG. 3 is a flowchart of the promotional content matching process according to one embodiment of the invention.

FIG. 4 is a flowchart of the promotional content fulfillment process according to one embodiment of the invention.

FIG. 5 presents an overview of the primary promotional content management functions according to one embodiment of the invention.

FIG. 6 is a class diagram illustrating classes of time sensitive scheduling data Activity Sources according to one embodiment of the invention.

FIG. 7 is a class diagram displaying the classes of affiliation states that may be used in matching promotional content to entities receiving activity content according to one embodiment of the invention.

FIG. 8 shows primary activity functions of a time sensitive scheduling data fulfillment process according to one embodiment of the invention.

FIG. 10 is an objects diagram illustrating basic attributes of promotional content data according to an embodiment of the invention.

FIGS. 11A-C are class diagrams illustrating entities of time sensitive scheduling data according to one or more embodiments of the invention.

### DETAILED DESCRIPTION OF THE INVENTION

Reference throughout this specification to “one embodiment” or “an embodiment” means that a particular feature, structure, or characteristic described in connection with the embodiment may be included in at least one embodiment of the present invention. Thus, the appearance of the phrase “in one embodiment” or “an embodiment” in various places throughout this specification does not necessarily refer to the same embodiment. Furthermore, the particular features, structures, or characteristics may be combined in one or more embodiments.

In the following description, for purposes of explanation, numerous details are set forth, such as flow charts and system configurations, in order to provide an understanding of one of more embodiments of the present invention. However, it is and will be apparent to one skilled in the art that these specific details are not required in order to practice the invention.

Accordingly, what is needed is a method of determining advertising relevancy that can make internet based behavioral targeting even more effective and cost efficient.

In one embodiment of the targeted promotional content network based on affiliation, the components are a type of activity data referred to as time sensitive scheduling data (TSSD) described herein, a set of functions which may encompass the collection, storage, maintenance and orderly dissemination of promotional content and TSSD, hardware and software which perform these functions and entities which produce and consume promotional content and TSSD.

### DEFINITIONS

As used in this description and the accompanying claims, the following terms shall have the meanings indicated, unless the context otherwise requires.

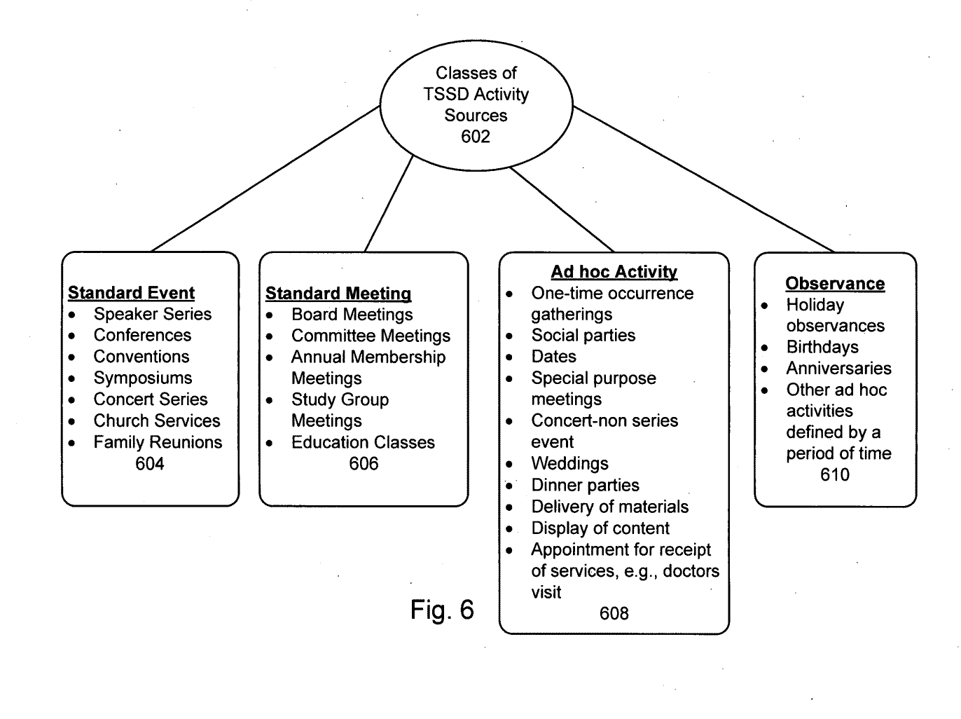

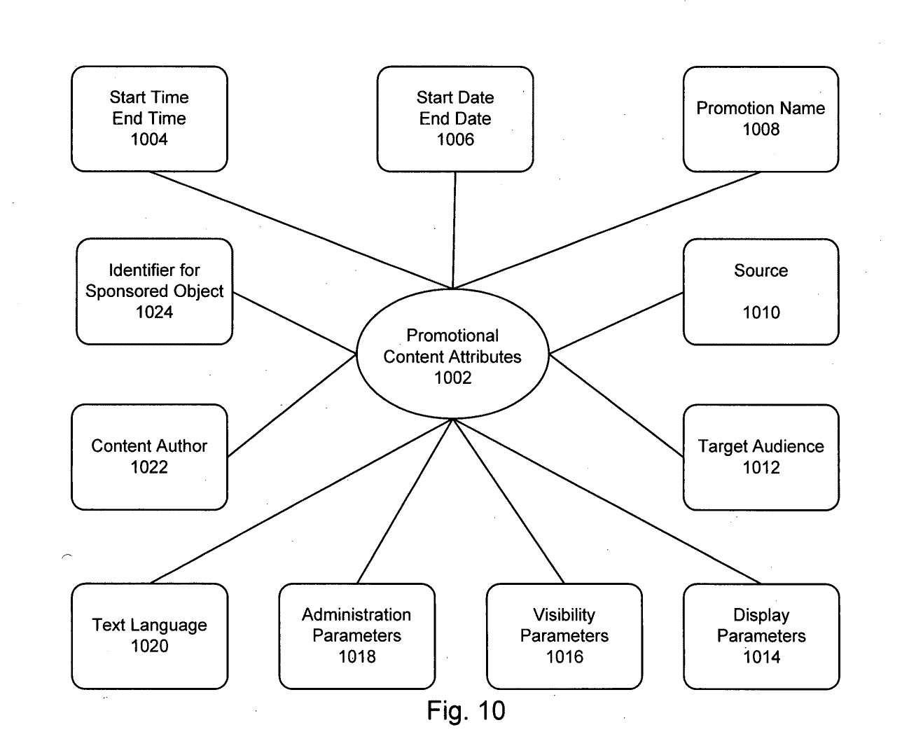

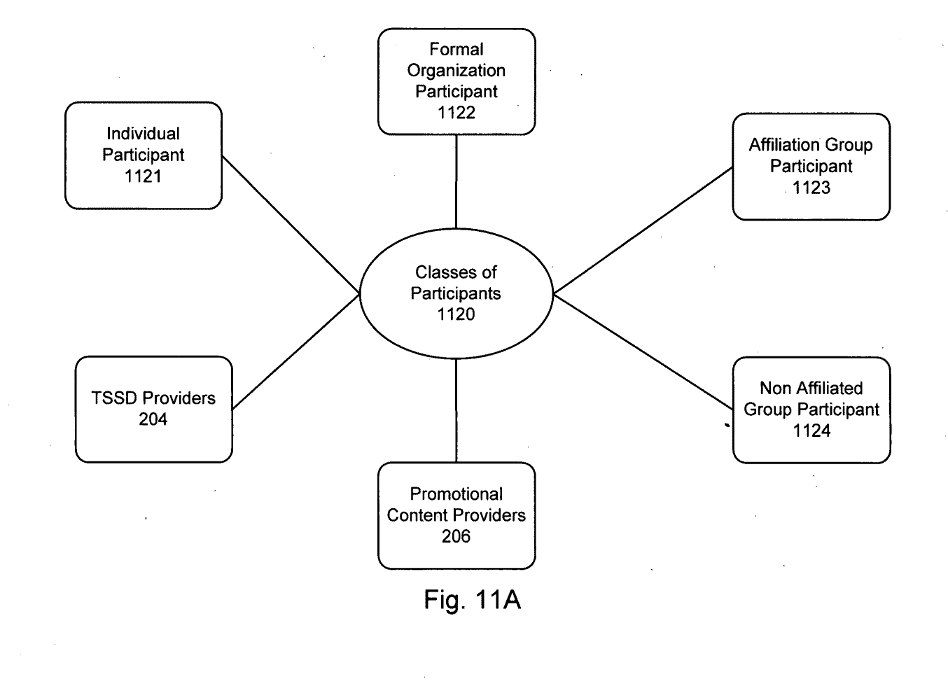

“Time sensitive scheduling data (TSSD)” refers to data relating to the class of entity activities including attending, timely participating, scheduling, planning, organizing, responding and reserving. The TSSD originates from activities sources from the class of TSSD activity sources including standard events, standard meetings, ad hoc activities, and observances. This TSSD data has high utility and is frequently referenced in its relationship to an individual's continually changing activities. Also, such data is not of transitory interest to users since checking one's schedule is a necessary activity that an individual does numerous times on a daily basis. In FIG. 6 is a class diagram that illustrates at least some of the sources for TSSD activities, while an objects diagram in FIG. 10 illustrates some basic attributes for promotional content.

“Promotion” may refer to dissemination of information about a product, a service, a product line or brand, a cause, a company, an organization and/or informal association, for example.

“Promotional Content” may refer to content that constitutes, for example, advertisement, sponsorship, product placement, endorsement, sales promotion, public relations, email campaigns and/or selling of goods and services.

“Affiliation Profile” may refer to a set of attributes within a profile which denote specific organizations (formal or informal), associations (formal or informal), and/or affinity for user specified areas of interest related to organizations, associations or activities. For example, a list of organizations to which an individual is a member, plus a list of organizations whose activities an individual regularly participates in, plus a list of activities to which an individual might regularly participate in with others (e.g., jazz concerts in the local park) would together provide the “affiliation profile” for that individual. This affiliation profile could then be used, for example, to generate affiliation criteria for promotional content matching purposes.

“Channel” may refer to a data stream containing one or more “profiled” (selected based on specific criteria which may include affiliation, derived interests, time frame, geographic basis of source and type of TSSD) and prioritized feed packets of content.

“Cloud” may refer to homogeneous groups of cooperating networks which deliver data from a source to a destination via one or more paths that may generally be determined by the cooperating networks components, and not by the originating source device or the destination receiving device. It should be appreciated that the path by which the data reaches the source may be unpredictable or unidentifiable in advance.

“Entity” may refer to consuming entities whose actions consume time sensitive scheduling data, producing entities whose activities produce time sensitive scheduling data, providing entities who submit time sensitive scheduling data intended for consumption by other entities, and receiving entities who control what is received and presented on the time sensitive scheduling data receiving device used for consumption of time sensitive scheduling data by entities. The consuming entities may include individual members or affiliates of time sensitive scheduling data delivery network client organizations, interested individuals who browse time sensitive scheduling data network communications sites, time sensitive scheduling data delivery network subscribers, members or affiliates of entities displaying time sensitive scheduling data activity feeds, and individuals passing by areas display time sensitive scheduling data activity feeds. The producing entities may include individuals, members of formal organizations, staffs of formal organizations, affiliated groups of individuals, viewers from non-affiliated groups, individuals in common interest groups, and individuals in a common space at the same time. Both the providing entities and receiving entities may include individuals, members of formal organizations, staffs of formal organizations, members of affiliated groups of individuals in non-formal organizations, and individuals in common interest groups.

Connectivity medium” means a medium (e.g., air, wire, or fiber) between two or more nodes that provides a communication network with a channel. In the present disclosure, the connectivity medium may function as a channel that communicates the required request, credentials, and keys that allow for the movement of TSSD.

“Distribute TSSD” may refer to the streaming of TSSD data to TSSD receiving devices when a specific profile match or a specific affiliation match is present or the receiving entity is known to the TSSD providing entity.

“Disseminate TSSD” may refer to the streaming of TSSD data to TSSD receiving devices when a specific profile match or a specific affiliation match may not be present or the receiving entity is unknown to the TSSD providing entity.

“Feed” may refer to a data stream containing one or more specific categories of content. Individual units of content may be designated as feed packets or payloads. Each feed may comprise a set of rules for pulling TSSD out of the data store.

“Need to Know data” may refer to data pertaining to activities or events which impact the health and safety of an individual, a community's members, an individual's relations or a specific group of individuals. Need to know time sensitive scheduling data may include activities which are generally non-routine, unscheduled or unplanned activities. Need to know time sensitive scheduling data may be data such as the occurrence of a natural disaster and its related recovery activities: opening of shelters, delivery schedule of food, water and supplies, and opening of relief services offices. Other examples may include road opening and closing schedules, school or public service office opening and closing schedules.

“Network” may refer to groups of computers, terminals, phones, cameras, and linking communications devices which may include routers, switches, hubs, antennas, and relays linked by wired or wire-less telecommunications systems for the purpose of exchanging data. Network, as used herein, may generally refer to a group of devices working together for a specific purpose involving the exchange of data.

“Server” may refer to any combination of computer hardware or dedicated computing device(s) and software which has as one of its functions the collection, storing, aggregation, packaging and/or dissemination of a specific class of data upon request. In one embodiment, a combination which comprises a server may be based on the homogenous data or data formats that are extracted from storage, manipulated if necessary by some set of rules or policies, and “served up” upon request from one or more entities or functions which consume the data to perform its processes. A single computer may host (provide) several server functions and a single server function may be hosted (shared/provided) by more than one computer or dedicated computing device.

“Site” means a reception zone for the receipt of TSSD that is cross-platform and cross-technology (e.g. web, handheld mobile devices, TV, kiosks, cellular phones, and other similar devices).

“Transmit” means to transfer data from one device to another device via one or more communications protocols, one or more communications media and one or more communication applications which facilitate the transfer of data across communications media by implementing one or more communications protocols. In an embodiment of the invention, TSSD and related collateral data can be transmitted via email, http protocol to a host browser over the Internet, via cellular or other telephony text messaging systems, via voice over a telephony network, over broadcast systems for radio, TV, cable and satellite and over evolving systems for extending the internet: Wi-Fi networks, public utility electrical systems, fiber optic communications systems, microwave communications, photoelectric communication system and wired local area networks.

In another embodiment of the invention, the passive delivery of the time sensitive scheduling data to the entity as described above may include the entity not having identified in advance the specific time sensitive scheduling data items delivered, not having requested the specific time sensitive scheduling data items which are transmitted based on a receiving device and consumer profile, and not having any content control of the specific time sensitive scheduling data items which have been delivered in advance of the time sensitive scheduling data items presentation.

In another embodiment of the invention, the passive delivery of the time sensitive scheduling data to the entity as described above may include the entity yielding control over the specific time sensitive scheduling data items selected for delivery, yielding control over the volume of time sensitive scheduling data items delivered, yielding control over how much information is delivered about the specific time sensitive scheduling data items, and yielding control over delivery time.

In another embodiment of the invention, the passive delivery of the time sensitive scheduling data to the entity as described above may include time sensitive scheduling data items selected for delivery based on the entity's derived interest and need to know related to the public health and safety of the entity and entity's current condition and state being impacted by the public health and safety issue.

In another embodiment of the invention, the time sensitive scheduling data items delivered as described above are selected from the group consisting of being known or unknown to a consuming entity in advance of their presentation, being not provided by the consuming entity, being targeted directly or indirectly at the consuming entity as a member of a class possessing specific attributes by the providing entities, belonging to a time sensitive scheduling data channel which has been subscribed to by the consuming entity, belonging to a time sensitive scheduling data channel which has been assigned to the consuming entity, pertaining to the time frame being presented by the time sensitive scheduling data receiving device, and a combination thereof.

According to another embodiment of the invention, an entity may include consuming entities whose actions consume time sensitive scheduling data, producing entities whose activities produce time sensitive scheduling data, providing entities who submit time sensitive scheduling data intended for consumption by other entities, and receiving entities who control what is received and presented on the time sensitive scheduling data receiving device used for consumption of time sensitive scheduling data by entities. The consuming entities may include individual members or affiliates of time sensitive scheduling data delivery network client organizations, interested individuals who browse time sensitive scheduling data network communications site, time sensitive scheduling data delivery network subscribers, members or affiliates of entities displaying time sensitive scheduling data activity feeds, individuals passing by areas display time sensitive scheduling data activity feeds, and a combination thereof. The producing entities may include individuals, members of formal organizations, staffs of formal organizations, affiliated groups of individuals, viewers from non-affiliated groups, individuals in common interest groups, individuals in a common space at the same time, and a combination thereof. Both the providing entities and receiving entities may include individuals, members of formal organizations, staffs of formal organizations, members of affiliated groups of individuals in non-formal organizations, individuals in common interest groups, and a combination thereof.

In another embodiment of the invention, the entity's affiliation profile is selected from the group consisting of attributes supplied by producer entities, attributes supplied by the targeted entity, attributes derived from the targeted entity's behavior in using the time sensitive scheduling data network to request time sensitive scheduling data, attributes derived from the targeted entity's behavior in selecting promotional content for detailed review, and a combination thereof.

In another embodiment of the invention, communications network based passive delivery of relevant and desired promotional content and time sensitive scheduling data to an entity may further comprise enabling advertisers and promoters to submit promotional content and target presentations to time sensitive scheduling data network entities.

In another embodiment of the invention, communications network based passive delivery of relevant and desired promotional content and time sensitive scheduling data to an entity may further comprise deriving affiliation for the entity by matching producing organization-to-consuming entity affiliations, by matching producing group-to-consuming entity affiliations, and by matching producing individual-to-consuming entity affiliations.

In an embodiment of the invention, the entity's affiliations may include membership from the group selected from the group consisting of appearing on rosters, membership rolls, employee rolls and subscriptions lists from producing entities, subscribing to time sensitive scheduling data channels of producing entities, designating affiliations in the entity's affiliation profile, resulting from other methods of deriving reliable affiliation data, and a combination thereof.

In another embodiment of the invention, communications network based passive delivery of relevant and desired promotional content and time sensitive scheduling data to an entity may further comprise deriving interest for the entity by matching the entity's attributes from the attribute groups selected from the groups consisting of entity-to-organization affiliations, entity-to-group affiliations, entity-to-individual affiliations, entity affiliation profile, selection of time sensitive scheduling data to receive further details about, selection of promotional content to receive further details about, selection of reminder notices for upcoming activities and observances, selection of reservations notices for upcoming activities, need to know criteria, affinity groups and a combination thereof.

In another embodiment of the invention, communications network based passive delivery of relevant and desired promotional content and time sensitive scheduling data to an entity may further comprise deriving activities for the entity from the entity's reservations time sensitive scheduling data and from the entity's use of the time sensitive scheduling data network.

In another embodiment of the invention, the entity's use of the time sensitive scheduling data network is selected from the group consisting of entity's requests for details on passively delivered promotional content and time sensitive scheduling data items, designating reminders, submitting life event time sensitive scheduling data items, subscribing to a producer entity's time sensitive scheduling data channel, receiving time sensitive scheduling data based on the entity's need to know, and a combination thereof.

In another embodiment of the invention, communications network based passive delivery of relevant and desired promotional content and time sensitive scheduling data to an entity may further comprise sending and receiving specific promotional content and time sensitive scheduling data related to activities of at least one of originating organizations, affiliated groups of individuals, and individual sources.

In another embodiment of the invention, communications network based passive delivery of relevant and desired promotional content and time sensitive scheduling data to an entity may further comprise transmitting specific promotional content aggregated as a part of time sensitive scheduling data streams of an aggregation of activities for a specific time frame related to sources including at least one of the group of an originating organization, an affiliated group of individuals, and an individual.

In another embodiment of the invention, the specific promotional content delivered is an aggregation of requested time sensitive scheduling data and promotional content for a specific time frame.

In another embodiment of the invention, communications network based passive delivery of relevant and desired promotional content and time sensitive scheduling data to an entity may further comprise streaming filtered, relevant and desired promotional content to the entity that fall into a specific category of time sensitive scheduling data and area of derived interest of the entity.

In another embodiment of the invention, communications network based passive delivery of relevant and desired promotional content and time sensitive scheduling data to an entity may further comprise delivering relevant and desired promotional content to the entity wherever the entity may be.

In another embodiment of the invention, communications network based passive delivery of relevant and desired promotional content and time sensitive scheduling data to an entity may further comprise accommodating the targeted delivery of relevant and desired promotional content and time sensitive scheduling data to a display device at a location where viewers matching a specific profile are trafficking.

In another embodiment of the invention, communications network based passive delivery of relevant and desired promotional content and time sensitive scheduling data to an entity may further comprise accommodating the delivery of relevant and desired promotional content and time sensitive scheduling data to a communications display in response to an occurrence of a specific event.

In another embodiment of the invention, communications network based passive delivery of relevant and desired promotional content and time sensitive scheduling data to an entity may further comprise accommodating the delivery of relevant and desired promotional content and time sensitive scheduling data to an audio device in response to an occurrence of a specific event.

In another embodiment of the invention, communications network based passive delivery of relevant and desired promotional content and time sensitive scheduling data to an entity may further comprise accommodating the delivery of relevant and desired promotional content and time sensitive scheduling data to the entity according to targeting criteria selected from the group consisting of affiliation between targeted entities, derived areas of interest of the consuming entity, entity's reminders, entity's reservations, entity's affinities, and a combination thereof.

In another embodiment of the invention, communications network based passive delivery of relevant and desired promotional content and time sensitive scheduling data to an entity may further comprise distributing and disseminating promotional content and time sensitive scheduling data which automatically provides targeted entities with promotional content and time sensitive scheduling data of personal interest to facilitate timely attendance and participation in a designated area of interest of the entity.

In another embodiment of the invention, communications network based passive delivery of relevant and desired promotional content and time sensitive scheduling data to an entity may further comprise distributing and disseminating promotional content and time sensitive scheduling data to the entity which automatically provides targeted entities with promotional content and time sensitive scheduling data of personal interest to facilitate timely attendance and collaboration in a designated area of affiliation of the entity.

In another embodiment of the invention, communications network based passive delivery of relevant and desired promotional content and time sensitive scheduling data to an entity may further comprise distributing and disseminating promotional content and time sensitive scheduling data to the entity which automatically provides targeted entities with promotional content and time sensitive scheduling data of personal interest to facilitate timely attendance at a designated reservation activity.

In another embodiment of the invention, communications network based passive delivery of relevant and desired promotional content and time sensitive scheduling data to an entity may further comprise distributing and disseminating promotional content and time sensitive scheduling data to the entity which automatically provides targeted entities with promotional content and time sensitive scheduling data of personal interest to facilitate timely follow up activity and collaboration in a designated reminder noticed activity.

In another embodiment of the invention, communications network based passive delivery of relevant and desired promotional content and time sensitive scheduling data to an entity may further comprise distributing promotional content and time sensitive scheduling data to targeted entities based on affiliations between the targeted entities.

In another embodiment of the invention, communications network based passive delivery of relevant and desired promotional content and time sensitive scheduling data to the entity may include distributing promotional content and time sensitive scheduling data to targeted entities based on targeted entities affiliations profiles.

The present invention can be implemented in various different forms, including but not limited to: business processes, computer implemented methods, computer program products, computer systems, and communication networks, entity interfaces, application programming interfaces, and the like.

The communications network may include simple devices, advanced devices, individual access devices, and community access devices.

The simple device may be a low-end price competitive device that receives TSSD. It may be able to send a Yes/No indicator in response to something on the device screen. The simple device may also receive TSSD based on who the entity is and/or what the interest profile is of the entity.

The aforementioned advanced device may have all the capabilities of the simple device plus some more additional communications capabilities. By way of example, such a device may have a full two-way interactive device. Some of its features may include a larger screen and easy manipulation of on-screen information. The advanced device may come in various sizes and shapes and changes where people may go to get critical information at several points during their day. The embedded systems devices may include cellular phones, PDAs, mobile digital assistants with cellular phones, text messaging devices and PDAs and Java (MIDP-mobile information device profile) enabled devices, multifunction wristwatches, and handheld computing devices.

Individual access devices such as the laptop computer, desk top computer, cellular phone, and PDA may allow a single entity to receive TSSD into a reception zone, often in a web browser format. These individual access devices typically already have web browser capability built-in. One of the access devices in this category is a web browser with a special web interface that is designed to receive TSSD. This mimics the advanced device functions somewhat, except as a web application. Another access device is a cellular phone using the web interface that is now available in many mid-to-high end cellular phones. Another access device is a PDA using the internet interface that is available now in cellular or Wi-Fi connected PDA devices. Other embedded systems devices can use non-web integration.

The community access devices may allow multiple entities to receive TSSD into a reception zone, often in a web browser type format. One of the access devices in this category may be a set top box, for example. The set top box may use the web interface and keyboards that are available with some set top box vendors. This is typically the in-home TV access to TSSD. Another reception zone is a kiosk. This is typically activity data shown in a communal or public area. Vertical kiosk applications come out of this area with payment structures such as from a sponsor paying to the public entity paying. In some parts of the world, this is a substitute for a local or regional newspaper or a way to check on government services without a long wait in lines. A third community reception zone is a broadcast channel which may allow the entity to receive TSSD into a reception zone on a broadcast media channel the entity is watching. These are zones of traveling message data strips on cable channels or more standalone captive areas like airport system screens. The scrolling TSSD seen there is based on location and the business function at that location. The media types for these streams are varied and include internet protocol, telephony, and both on-air cable and private cable.

In a pure push system, content may be streamed to an entity as determined by the providing entity. The entity has the option of consuming (i.e., viewing, listening, or feeling) the content or ignoring the content. In one modified push system, the entity may have the option to block (filter) unwanted content and the providing entity cannot override the consuming entity's choice not to receive specific types of content.

In a pure pull system, an entity requests specific available content and the content is streamed to the entity's receiving device for consuming (i.e., viewing, listening, or feeling). In one modified pull system, the entity may request a category of content or specific content, but the provider has the option to target specific consumers and thereby filter what is streamed to an entity. The entity cannot override the providing entity's choice not to stream content to the specific entity.

In the TSSD delivery network, the types of data collected from providing entities may include meeting information, event information, and volunteer opportunity information. Based on this type of collected data, public alerts, free public service announcements, paid promotions, and paid advertising can be targeted effectively.

In an embodiment of the invention public TSSD may be activity content provided with the intent of this content being consumed (i.e., viewed, heard, or felt) by affiliated or subscribed entities. The intent may be to inform others by providing this content for distribution to affiliated entities.

A single piece of promotional content (promo) may possess many attributes explicitly captured or implied which can be used for targeting entities who may be interested or will respond to the promotional messaging. Thus, promotional content may have attributes which can be matched to an organization, an informal association of individuals, a group of individuals participating in or expressing interest in a common event or activity, or to a entity's profile for targeting purposes. The attributes may include biological, geographical, psycho graphical, affiliation, educational, professional, and inferred behavioral data items.

The TSSD delivery network can contain within it very valuable data for which advertisers and marketers pay premium amounts. The TSSD delivery network is rich in information because it may be categorize the data automatically along at least three dimensions: profile; behavior; and responses.

In one embodiment, the first dimension may be profiles. All entities may create TSSD having profiles rich in information about what they do via their associations including their derived interests, hobbies, expertise, and similar activities. Entities may include individuals, members of organizations, and organizations. The TSSD communications network based passive delivery method characterizes that information across the TSSD delivery network for advertisers.

According to another embodiment, the second dimension is behavior. Behavior may include a entity's choice of affiliation. Timely up-to-date information can be implied from entity choices and actions within the TSSD delivery network. For example, the entity that is a member of three organizations gives indicators to three or more major areas of interest because there are profiles on (most) entities within the TSSD delivery network, which include their purpose and mission.

According to another embodiment, the third dimension may be responses. Responding to the advertisements themselves may create additional TSSD for the TSSD delivery network. Valuable response information may then be captured in at least two ways. Many entities will be responding to event and meeting notices that tie them to an area of interest, which can then be used in matching marketing data characteristics to advertisers. And similarly, when an entity sees an advertiser's advertisement or message, the entity can respond usually by going to a more detailed descriptive message. This action may create additional TSSD and a kind of meta-characteristic of interest based on the non-search criteria.

Given a set of characteristics that an advertiser wants to reach, the promotional content matching based on affiliation method may deliver the advertisement or message via the TSSD delivery network to a metro zone, state, region or to the entire TSSD delivery network, but only to those individuals matching the advertisers' designated characteristics, for example.

The promotional content fulfillment process may allow promoters to provide subscribers with promotions or advertisements that fall, for example, specifically into their areas of interest. A sponsor or other advertisement placement buyer may pay for these services that result in promotional messages transmitted to hand-held communications devices or other types of devices that have built-in reception capability. This may allow sponsors of an organization to place advertisements for delivery within one association or across the entire TSSD delivery network.

In one embodiment, the promotional content management functions may include: 1) adding/updating promotional content and its attributes; 2) previewing promotional content; 3) deleting promotional content; 4) purging expired promotional content; 5) extracting promotional content based on matching criteria; and/or 6) maintaining historical data.

According to another embodiment, the promotional content fulfillment process may involve both a modified push system in which promotional content is sent to the entity, and a modified pull system in which the entity requests the promotional content details or opens a gateway to new promotional content. At any given moment a entity may be receiving pushed promotional content from one or more TSSD channels streams based on the list of channels which the entity has authorized, i.e., chosen to monitor. In addition, the same entity maybe receiving pushed promotional content which is sponsoring the chosen association or content which is targeted at the specific TSSD channel.

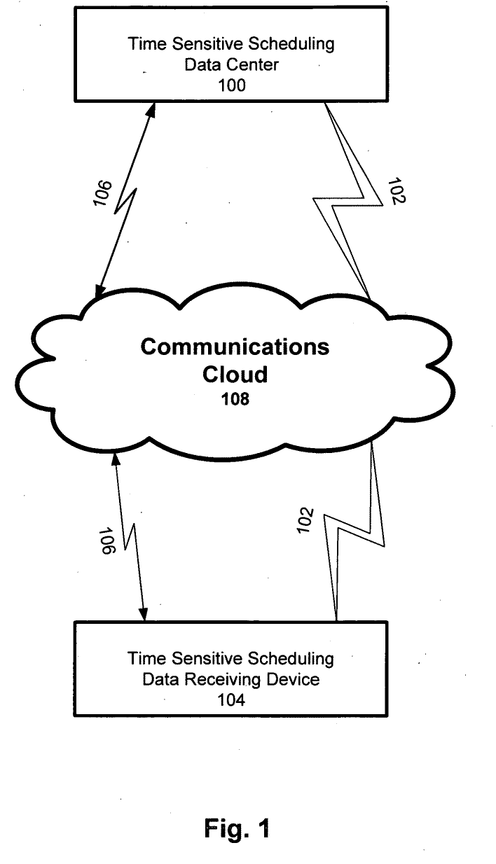

FIG. 1 is a simplified schematic of a communications network configured in accordance with the principles of one embodiment of the invention. In the embodiment of FIG. 1, a TSSD center 100 collects and stores TSSD via a connectivity medium 102. A TSSD receiving device 104 may then transmit authentication information to the TSSD center 100, via a connectivity medium 106, to a communications cloud 108. The authentication information may contain a subscription fulfillment request, and credentials which include location information (Internet Protocol (IP) address, media access control (MAC) address, mobile identification number (MIN), electronic serial number (ESN), Box ID, subscription channel ID, subscriber ID, or similar ID uniquely identifying the TSSD receiving device 104), and authorization and decoding encryption keys.

The TSSD center 100 may then validate the entity's subscription fulfillment request and credentials received from the communications cloud 108 via the connectivity medium 106. If the credentials are valid, the TSSD via the connectivity medium 102 may be returned to the TSSD receiving device 104 through the communications cloud 108. If the credentials are invalid, a rejection message may be transmitted to the TSSD receiving device 104, via the connectivity medium 106, through the communications cloud 108. The TSSD center 100 streams the promotional content and TSSD via the connectivity medium 102 related to an organization's, association's, and individual's events, activities, and meetings.

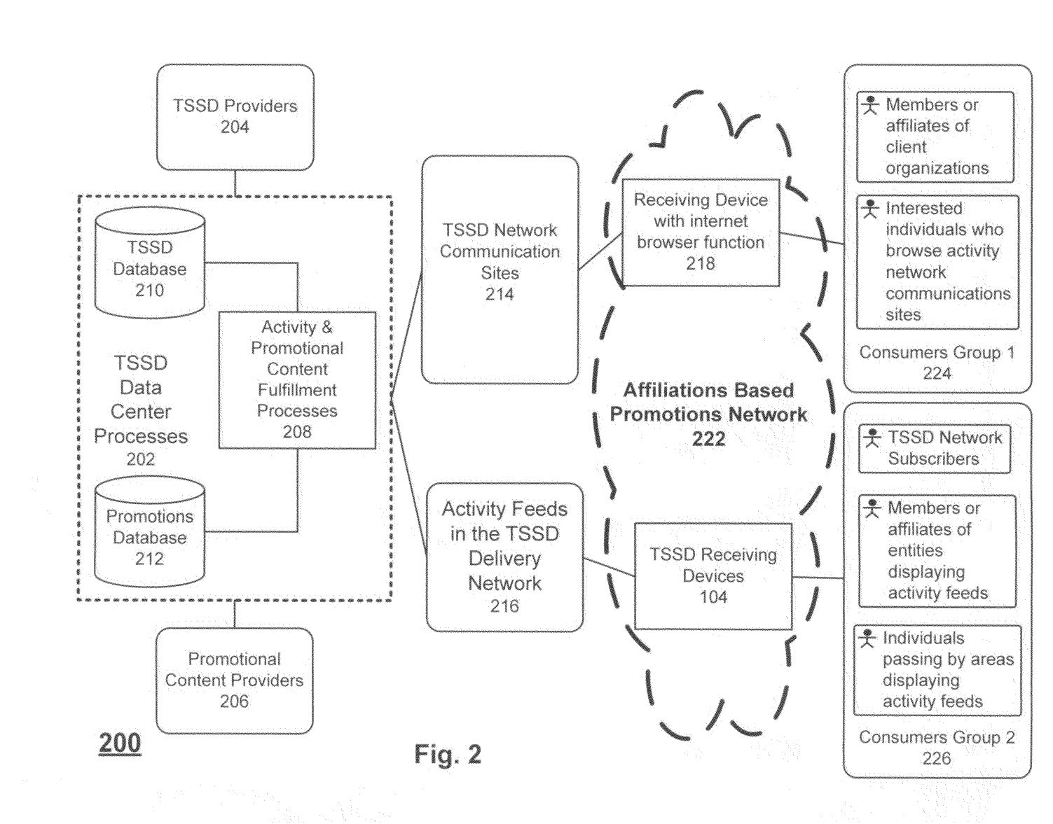

FIG. 2 is one embodiment of a representation of a promotions network 200 based on affiliation manifested at any point in time by Activity Feeds in the TSSD Delivery Network 216. In this embodiment, activity content from TSSD Providers 204 may be maintained in the TSSD Database 210 and promotional content from Promotional Content Providers 206 may be maintained in the Promotions Database 212 by TSSD Data Center Processes 202. When entities in Consumers Group 1 224 and Consumers Group 2 226 initiate sessions in the Affiliations Based Promotions Network 222 via receiving devices, which may include receiving devices with internet browser functions 218 and TSSD Receiving Devices 104, the Activity & Promotion Content Fulfillment Processes 208 may extract and transmit activity and promotional content which may appear on TSSD Network Communications Sites 214 and in Activity Feeds in the TSSD Delivery Network 216. In this embodiment of the invention, promoters may target their content at Consumers Group 1 224: members or affiliates of client organizations and interested individuals who because of their affiliation browse the activity network communications sites such as the TSSD Network Communication Sites 214. Promoters may also target their content at Consumers Group 2 226: TSSD Network Subscribers, members or affiliates of entities displaying activity feeds and individuals who pass by or through an area displaying activity feeds who because of their affiliation, affinity or interest view the activity content on TSSD Receiving Devices 104.

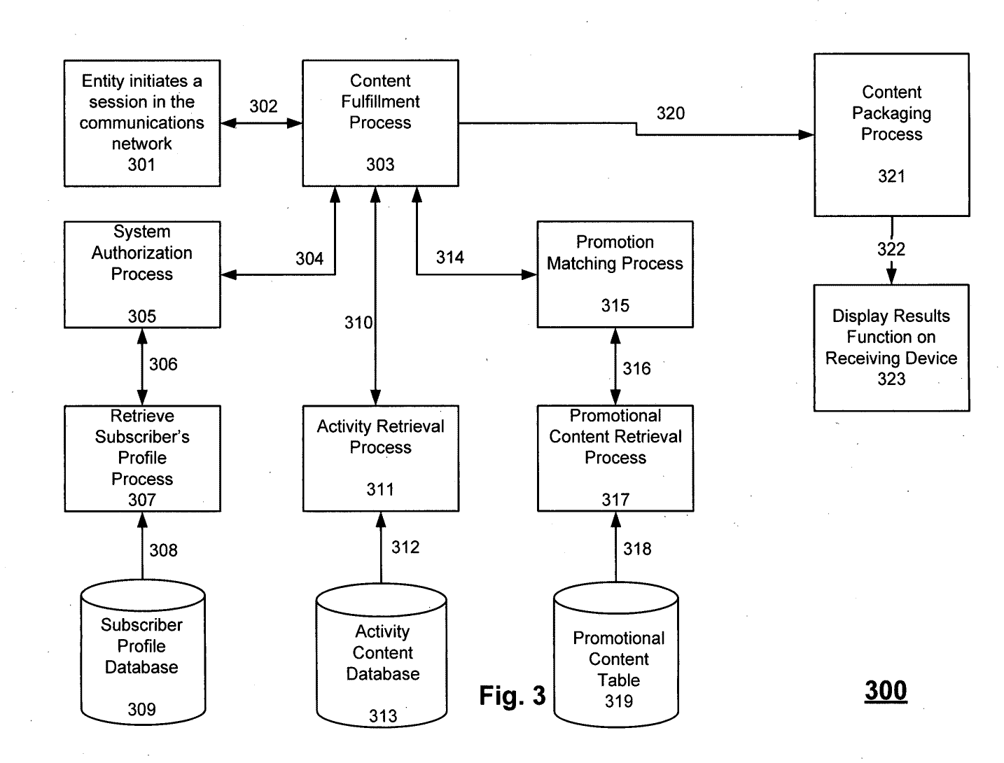

FIG. 3 is a flowchart of the promotional content matching process 300 according to an embodiment of the invention showing its relationship to an activity content delivery system. As represented in FIG. 1, the entities have access to activity content data streams wherever and whenever they have possession of or access to TSSD receiving devices 104 which have connectivity to the TSSD center 100 via the Internet connectivity mediums 106 and 102, and the devices have access via the communications cloud 108. In certain embodiments, entities may receive matching promotional content bundled with the activity content in conjunction with the delivery of activity content.

In an embodiment of the invention relating to the TSSD delivery network, an entity may initiate a session in the TSSD delivery network and receives TSSD content and matching promotional content on the entity's receiving device as described below. An entity who initiates a session in the communications network 301 may transmit on line 302 authorization credentials to the Content Fulfillment Process 303. The Content Fulfillment Process 303 may then transmit the submitted authorization credentials on line 304 along with a request for the entity's subscriber profile to the System Authorization Process 305. This profile may contain attributes of the entity, including for example the entity's affiliations, affinity groups and/or areas of interests for activities/associations. The System Authorization Process 305 may then perform entity validation checks and verification functions. If the entity is not valid, has expired credentials or is otherwise deemed to be unauthorized, the System Authorization Process 305 may transmit on line 304 to the Content Fulfillment Process 303 the unauthorized state for the entity. The entity may also be notified on line 302. If, on the other hand, the entity is authorized, the System Authorization Process 305 may transmit on line 306 to the Retrieve Subscriber's Profile Process 307 a request for the entity's Subscriber Profile.

Continuing to refer to FIG. 3, the Retrieve Subscriber's Profile Process 307 may extract the subscriber's profile on line 308 from the Subscriber Profile Database 309. The Retrieve Subscriber's Profile Process 307 may transmit the subscriber profile on line 306 to the System Authorization Process 305 which, in the embodiment of FIG. 3, may then forward on line 304 the subscriber profile to the Content Fulfillment Process 303.

In one embodiment, the Content Fulfillment Process 303 uses the information from the entity's subscribers profile to generate an activity retrieval request in the form of activity extraction criteria and to generate a promotional content retrieval request in the form of promotional content matching criteria. This criterion may include, among other identifiers, the affiliation profile: a entity's affiliations, affinity groups and/or areas of interest for activities/associations.

Continuing to refer to FIG. 3, the Content Fulfillment Process 303 may then transmit on line 310 an activity retrieval request to the Activity Request Process 311. The Activity Request Process 311 may then extract any matching activity content from the Activity Content Database 313 on line 312. The Activity Request Process 311 may then transmit the matching activity content on line 310 to the Content Fulfillment Process 303.

In the embodiment of FIG. 3, the Content Fulfillment Process 303 transmits on line 314 a promotional content retrieval request to the Promotion Matching Process 315, where such request may include the entity's affiliation profile, device type, preferences and/or interests. The Promotion Matching Process 315 may then generate a promotion matching criteria by adding contextual information, such as time of day, entity language requirements, and entity location to the promotional content retrieval request and transmits on line 316 the promotion matching criteria to the Promotional Content Retrieval Process 317. The Promotional Content Retrieval Process 317 on line 318 extracts matching promotional content, if any, from the Promotional Content Table 319. The Promotional Content Table 319 may contain the promotional content's media files, text, accompanying graphics, and administrative attributes such as targeted affiliations, provider identification, placement requirements, desired frequency, and expiration time and date. The Promotional Content Table 319 also may include administrative information about the actual promotion content available such as categories of content available and global provisioning restrictions. The Promotional Content Retrieval Process 317 formats the extracted content for the entities receiving device type and transmits on line 316 the matching promotional content to the Promotion Matching Process 315. The Promotion Matching Process 315 is depicted as also transmitting the status of the request for matching promotional content and the formatted matching promotional content, if any, on line 314 to the Content Fulfillment Process 303.

In addition, the Content Fulfillment Process 303 may transmit on line 320 a fulfillment package which may include administrative status information about the request for activity content, any activity content extracted and the matching promotion content, if any. The Content Packaging Process 321 may generate bundles of content and transmits them on line 322 to the Display Results Function on Receiving Device 323. The bundles of content may be formatted for a specific entity device or unformatted. The bundles of content may include activity content, matching promotional content and administrative messages from the various processes involved in the matching promotional content fulfillment process.

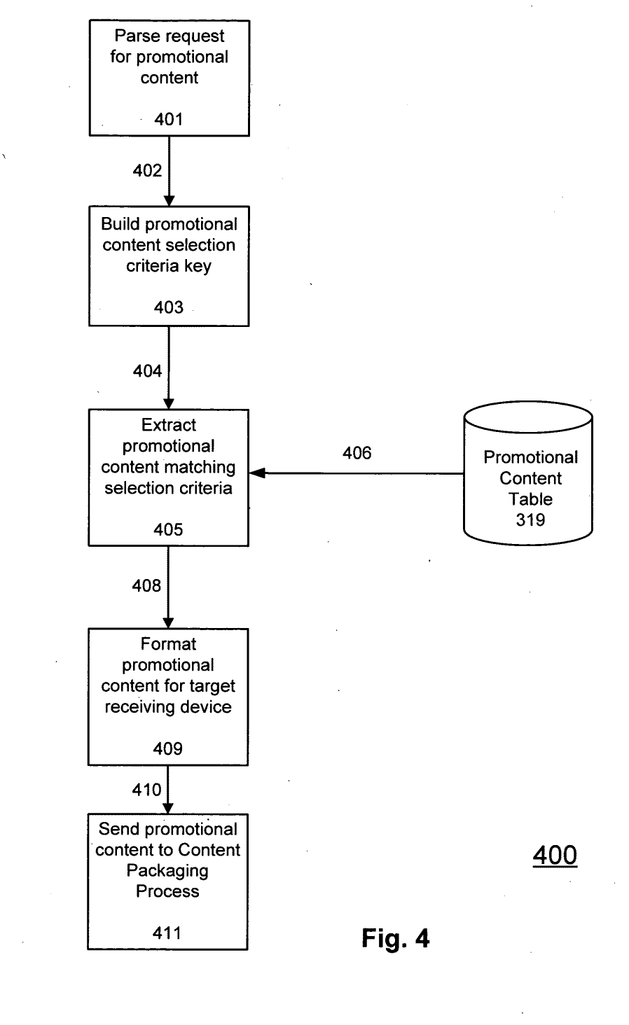

FIG. 4 is a flowchart of certain functions of a promotional content fulfillment process 400, in accordance with one embodiment of the invention. Initially, the parse request for promotion content function 401 may receive and interpret the request and any administrative data accompanies the request. The translated results, which may include requesting device type, identification of the source activity feeds, entity's affiliations with provider client organizations of the TSSD delivery network, and entity interest profile data, may be transmitted on line 402 to the build promotional content selection criteria key 403 where a selection criteria key may be generated in order to extract promotional content matching the activity content which caused the promotion content request. The promotional content selection criteria key may then be transmitted on line 404 to the extract promotional content matching selection criteria function 405.

The extract promotional content matching selection criteria function 405 may then perform the necessary actions to extract matching content on line 406 from the Promotional Content Table 319. The extract promotional content matching selection criteria function 405 may transmit on line 408 the matching promotional content, if any, and the status of the extraction request to the format promotional content for target receiving device function 409. The format promotional content for target receiving device function 409 may then perform actions to remove device incompatible media and formatting, performs basic reformatting of promotional content for the receiving device, if necessary, and updates administrative request status information. The results of these actions are transmitted on line 410 to the send promotional content to the content packaging process 411. The send promotional content to the content packaging process 411 transmits the matching promotional content, if any, and status information to a fulfillment process. Content Package Process 321 may then bundle the matching promotional content with the activity content.

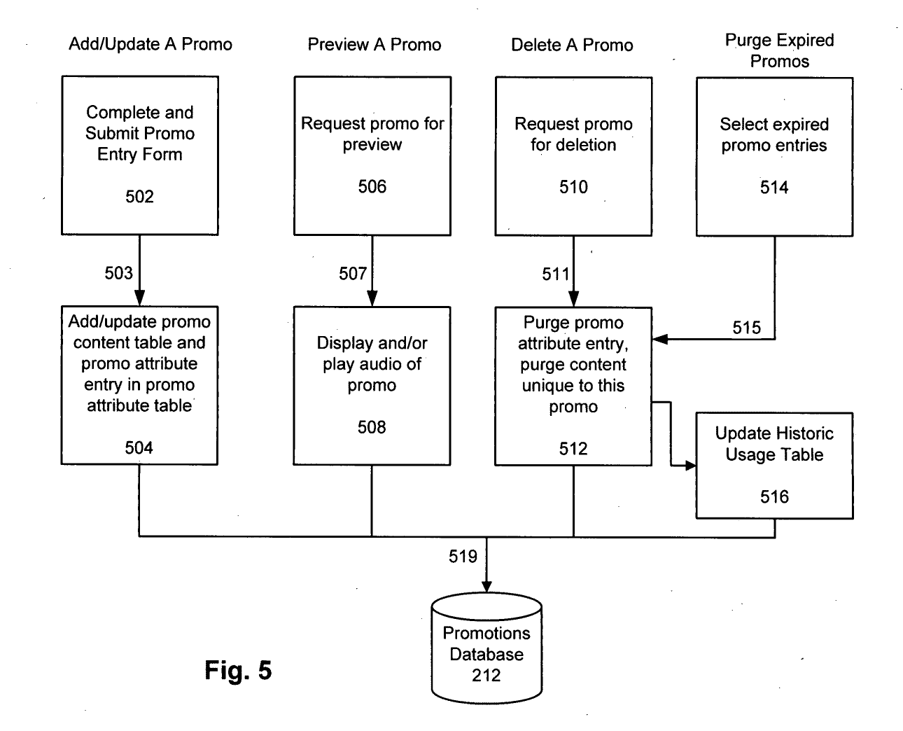

FIG. 5 presents an overview of at least some of the promotional content management functions, according to one embodiment of the invention. The term “promo” as used in FIG. 5 is used to refer to a unit of promotional content. The basic promotional content management functions may include: add/update a promo, preview a promo, delete a promo and purge expired promos.

The add/update a promo function encompasses electronically completing and submitting a promo entry form 502, transmitting the form data on line 503 to a process 504 which on line 519 adds or updates the promo content table entry for the promo and which adds or updates the promo attribute entry in the promo attribute table in the Promotions Database 212. Promo attributes may include starting and ending dates for the promo, display limits, targeted affiliations, targeted areas of interest, and source provider identifier.

The preview a promo functions may encompass requesting the promo for preview 506, transmitting the promo content retrieved on line 507 to a process 508 which extracts the promo content on line 519 from the Promotions Database 212 and displays the promo and/or plays the audio portion of the promo.

The delete a promo function encompasses requesting a promo for deletion 510, transmitting the promo identifier on line 511 to a process 512 which on line 519 purges all promo content unique to this promo and the promo's attribute entry in the promo attribute table.

Similarly, the purge expired promos function may encompass selecting all expired promo entries 514, transmitting the promo identifiers on line 515 to a process 512 which on line 519 purges all promo content unique to these promos and the promo attribute entries of these promos in the promo attribute table in the Promotions Database 212. Finally, the delete promo and purge expired promos function may also encompass a process 516 which updates the historical usage table on line 519 in the Promotions Database 212.

FIG. 6 is a class diagram illustrating the classes of TSSD Activity Sources 602 according to an embodiment of the invention. In the class diagram are described common TSSD Activity Sources. These classes for TSSD Activity Sources 602 may include Standard Events 604, Standard Meetings 606, Ad Hoc Activities 608, and Observances 610. The term gathering, as used herein, may be considered in a metaphorical context and is not intended to indicate only geographic presence or proximity. For example, in celebrating holidays or life events (e.g., birthdays or wedding anniversaries), a number of people may give credence or significance to a period or point in time, but may not necessary gather together in the same geographic space.

Standard Events 604 may relate to routine and non-routine gatherings of the same or ad hoc groups of individuals in association for purposes other than conducting the regular business of the associations. Standard Events 604 may include speaker series, conferences, conventions, symposiums, concert series, church services, and family reunions.

Standard Meetings 606 may relate to generally recurring gatherings of the same individuals for the purpose of conducting the business of the association. Standard Meetings 606 may include board meetings, committee meetings, annual membership meeting, study group meeting, and educational classes.

Ad Hoc Activities 608 may encompass all other pre-announced gatherings of individuals for social purposes. Ad Hoc Activities 608 may include ad hoc associations, one-time occurrence gatherings, social parties, social dates, special purpose/ad hoc meeting, non-series concerts, weddings, dinner parties and logistical events such as the delivery of materials, displays of some content or an appointment to receive services.

Observances 610 may include routine recognition of a holiday or special activity date such as Election Day or tax due date and ad hoc life events such as a birth or a marriage. Observances 610 may be mass recognitions of an ad hoc event or may be ad hoc or routine gatherings of the same or ad hoc groups of individuals in association for purposes of recognizing an event or occurrence.

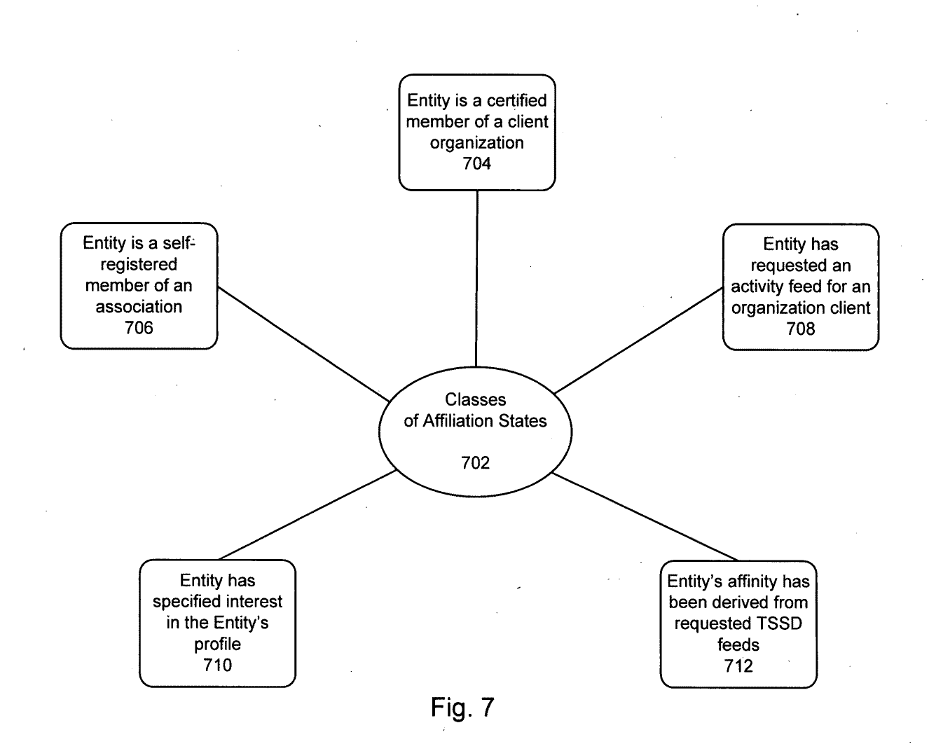

FIG. 7 is a class diagram displaying classes of affiliation states 702 that may be used in matching promotional content to entities receiving activity content according to one embodiment of the invention. The term entity in this context may refer to a consumer of activity and promotional content from an embodiment of the invention. The term entity in this context may be a person or group of individuals observing a device interfacing with an embodiment of the invention. At least one embodiment of the invention may be implemented in a real-time state in which an entity may be in one of the following affiliation states in relation to a unit of activity content: entity is a “certified member” of a client organization 704 (based on the entity being designated a member by the organization and appearing in the organization's member database), entity is a self-registered member of an association 706 (i.e., entity affiliated with an informal organization is a self-registered or designated as member of the association), entity (subscriber) has requested an activity feed for an organization client 708 of the activity delivery network, entity has specified interest in the entity's profile 710 (i.e., belongs to a class of people with similar interest creating a virtual affiliation), and entity's affinity has been derived from requested TSSD feeds 712 (i.e., entity is a member of an affiliated group which has been derived from the entity's requested activity feeds) The affiliation is based on behavior within the activity content delivery system.

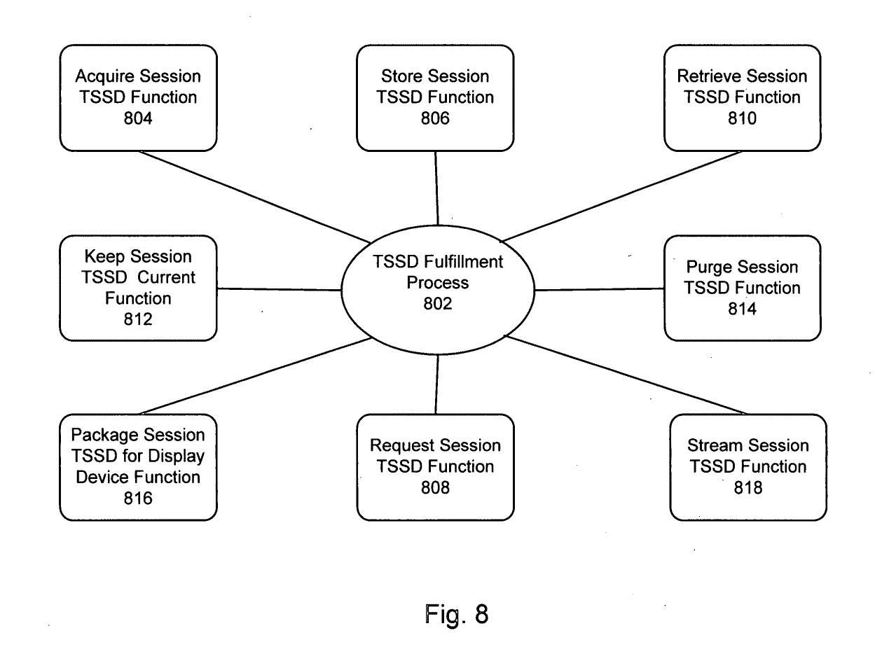

FIG. 8 shows an object diagram displaying the following primary activity functions of the TSSD fulfillment process 802: acquire session TSSD function 804; store session TSSD function 806; request session TSSD function 808; retrieve session TSSD function 810; keep session TSSD current function 812; purge session TSSD function 814; package session TSSD for display device function 816; and stream session TSSD function 818, according to one or more embodiments of the invention. Various activity data collection mechanisms may enable TSSD fulfillment process 802 to create the TSSD data stream for an entity session. Activity data collection mechanisms may include various multi-platform, multi-communications TSSD receiving devices or web browsers. These TSSD receiving devices may include simple devices, advanced devices, embedded systems devices, individual access devices (e.g., cellular phones, PDAs), and community access devices (e.g., set tops equipped with input devices, kiosks ) or these web browsers may include PDAs, PCs, cellular phones, tablet PCs. Other data collection mechanisms may include call centers that provide direct contact information transfers and bulk purchase of activity data from vendors.

In one embodiment, the stream session TSSD function 818 may assemble a data stream containing one or more profiled and prioritized feed packets of content known as a channel. The channel may now be ready to be transmitted to windows in display devices. The display devices may be portable or fixed placement. The portable display devices may include mobile computing devices, PDAs, cellular phones, personal computers, portable workstations, and a combination thereof. The fixed placement display devices may include public place business display screens, home entertainment appliance displays, business display screens in a public place, business display screens on company property in public areas, business display screens on company property in private areas, and a combination thereof.

FIG. 10 is an objects diagram illustrating basic attributes of Promotional Content 1002. In the objects diagram of FIG. 10, may be defined sets of Promotional Content attributes 1002. These Promotional Content attributes 1002 can include: Start Time/End Time 1004; Start Date/End Date 1006; Promotion Name 1008; Source 1010; Target Audience 1012; Display Parameters 1014 may include graphics, logos, captions, and colors; Visibility Parameters 1016 (e.g., posting date, hide flag); Administration Parameters 1018(e.g., who created, when created); Text Language 1020; Content Author 1022; and Identifier for Sponsored Object 1024.

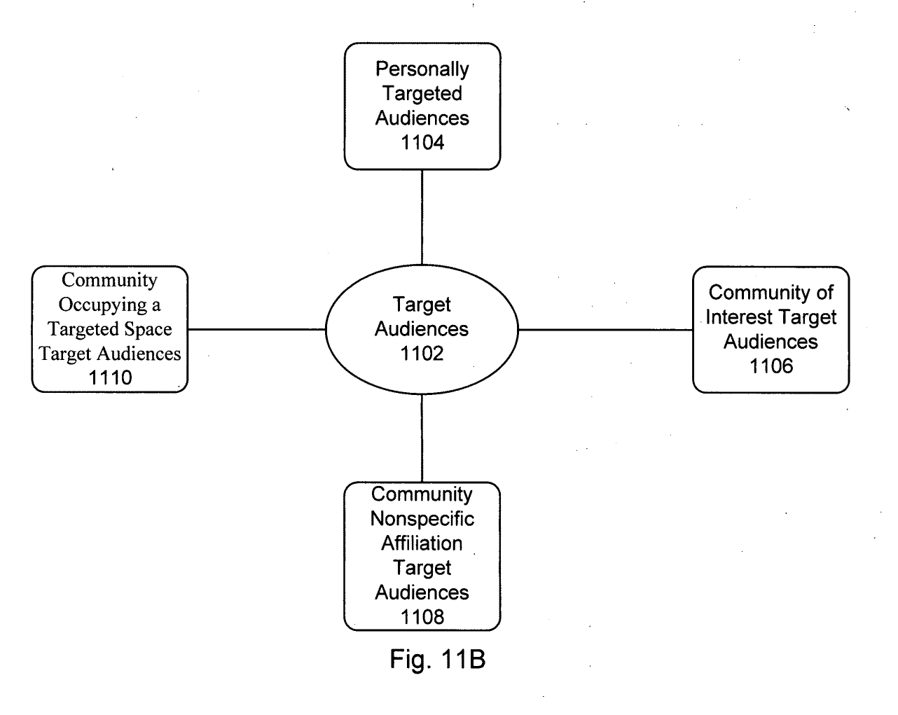

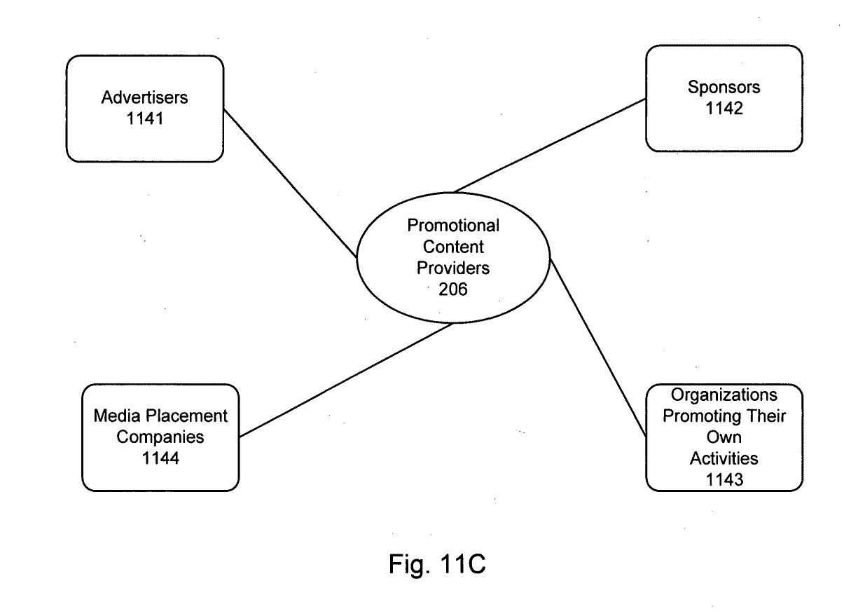

FIG. 11A is a class diagram illustrating the entities that comprise classes of participants 1120 according to at least one embodiment of the invention. These classes of participants 1120 may fall into one or both of the categories of providers of content, TSSD Providers 204 and Promotional Content Providers 206, or consumers of TSSD (target audiences in FIG. 11B). In the FIG. 11A class diagram are described the participating entities. An individual participant 1121 may be any person acting in their own interest, for example. A formal organization participant 1122 may be an organization which is certified by any authority generally recognized as a governing body and which may have a formalized membership structure. Examples of formal organizations range from companies with staff to trade associations like the American Bar Association to little league teams. An affiliation group participant 1123 may be an informal association of individuals which has a loose membership structure or simple affiliation mechanism. Examples of affiliated groups may include fan clubs, pickup teams, typical internet social networks and groups of school friends. A non-affiliated group participant 1124 may be a group of individuals that share common characteristics but are not directly associated with each other. Examples of non-affiliated group participants may be passengers in an airport terminal, fans attending a sports event or concert and adults age 26-35.

FIG. 11B is a class diagram illustrating target audiences according to an embodiment of the invention. In the FIG. 11B class diagram are displayed the primary audience classes of Target Audiences 1102.

In one embodiment, Personally Targeted Audiences 1104 may be individuals to whom specific TSSD and promotional material are streamed based on the attributes and preferences explicit in their personal profile in the TSSD delivery network. Personally Targeted Audiences 1004 may include audiences targeted by self-chosen membership or direct affiliation with a TSSD delivery network product client. Examples of Personally Targeted Audiences 1104 may include active members of a service or social club, lapsed members of a trade association, board members of a not-for-profit organization, board members, staff or clients of a business, and individual subscribers to the TSSD delivery network services.

Community of Interest Target Audiences 1106 may correspond to audiences who share identified common affiliations deemed significant for this invention and to whom specific TSSD and promotion materials are streamed based on their affiliations, the common attributes derived for the community group, and the specific preferences of significant members of the community group. Community of Interest Target Audiences 1106 may include dentist, alumni of a college, fans of an artist or genre of music, and wine lovers who prefer cabernet sauvignon.

In one embodiment Community Nonspecific Affiliation Target Audiences 1108 may be audiences who share identified common attributes deemed significant for this invention and to whom specific TSSD and promotion materials are streamed based on the common attributes and affiliations derived for the community group, and the specific preferences of significant members of the community group. Community Nonspecific Affiliation Target Audiences 1108 may include adults age 26-35 or people who attended a conference on space exploration last year.

Community Occupying a Targeted Space Target Audiences 1110 may be audiences who share a common space (physical or virtual) at a targeted time deemed significant for this invention and to whom specific TSSD and promotion materials are streamed based on the occupancy of that space at that time. Community Occupying a Targeted Space Target Audiences 1110 sharing a physical space may include sports, concert, performing arts event attendees, attendees of conferences and conventions, attendees at public festivals such as art and wine festivals or food festivals, attendees at political rallies and attendees at private events such as weddings, roasts, church services and/or observances. Community Occupying a Targeted Space Target Audiences 1110 sharing a confined space may also include passengers on a bus, boat, plane or train. Community Occupying a Targeted Space Target Audiences 1110 sharing a virtual space may include all internet entities browsing a particular organization's website, all phone entities participating in a conference call, and ail attendees to a virtual web conference.

FIG. 11C is a class diagram illustrating providers of the specific promotional content according to an embodiment of the invention. In the class diagram are described the Promotional Content Providers 206. Promotional Content Providers 206 may be the originating entities for the event or activity or they may be merely submitting the Promotional Content attributes 1002 of FIG. 10.

An advertiser 1141 may be an entity acting in its own interest that provides promotional content in the form of advertising related to its or its affiliates own products, services or brands to the affiliations based promotions network.

A sponsor 1142 may be an entity acting in its own interest that provides promotional content in the form of sponsoring certain displays, displayed pages, displayed objects and/or specific activity content not related to their own products, services or brands in exchange for having their name, logo or similar identifier place in proximity to the sponsored object.

Organizations promoting their own activities 1143 may be client organizations that provide paid advertisements or sponsorships in the form of promotional content targeted to appear along with the TSSD content for one of their activities. For example, an organization may pay to sponsor any calendar page within the TSSD Delivery Network that is displaying their major fundraiser.

In one embodiment, Media Placement Companies 1144 may be business entities that act on behalf of a client of theirs to promote their clients products, services or brands. In this agency capacity the media placement company provides promotional content, content attributes and targeting attributes for the affiliations based promotions network.

The invention is preferably implemented by software, but can also be implemented in hardware or combination of hardware and software. The invention can also be embodied as computer readable code on a computer readable medium. The computer readable medium is any data storage device that can store data which can thereafter be read by a computer system. Examples of the compute readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The drawings and the foregoing description gave examples of the present invention providing a time sensitive scheduling data delivery network and related aspects. Although depicted as a number of disparate functional items, those skilled in the art will appreciate that one or more of such elements may well be combined into single functional entities. Alternatively, certain elements may be split into multiple functional elements. The scope of the present invention, however, is by no means limited by these specific examples. Numerous variations, whether explicitly given in the specification or not, such as differences in structure, dimension, and use of material, are possible. Although the present invention has been described in considerable detail with reference to certain embodiments thereof, the invention may be variously embodied without departing from the spirit or scope of the invention. Therefore, the following claims should not be limited to the description of the embodiments contained herein in any way.

What is claimed is:

1. A method for communications network based passive delivery of relevant and desired promotional content and time sensitive scheduling data to an entity, comprising:
targeting promotional content based on targeting criteria;
distributing via a passive delivery communications network promotional content based on the targeting criteria;
delivering via the passive delivery communications network promotional content aggregated as part of time sensitive scheduling data streams; and
presenting passive delivery of promotional content in proximity to relevant time sensitive scheduling data to the entity via a time sensitive scheduling data receiving device.

2. The method of claim 1, wherein the targeting criteria is affiliations between targeted entities.

3. The method of claim 1, wherein the targeting criteria is an entity's activities.

4. The method of claim 1, wherein the targeting criteria is an entity's derived and designated interest in specific categories of the time sensitive scheduling data.

5. The method of claim 1, wherein the targeting criteria is an entity's request for specific time sensitive scheduling data.

6. The method of claim 1, wherein the targeting criteria is an entity's affiliation profile.

7. The method of claim 1, wherein the time sensitive scheduling data consists of data relating to a class of entity activities originating from a class of time sensitive scheduling data activity sources.

8. The method of claim 7, wherein the class of entity activities is selected from the group consisting of attending, timely participating, scheduling, planning, organizing, timely responding, reserving, and a combination thereof.

9. The method of claim 7, wherein the class of time sensitive scheduling data activity sources is selected from the group consisting of standard events, standard meetings, ad hoc activities, observances, and a combination thereof.

10. The method of claim 1, wherein the passive delivery of time sensitive scheduling data includes deriving interest for targeting a receiving entity based on information from provider organization's membership rolls and affiliation rolls as they pertain to entity items selected from the group consisting of entity-to-organization affiliations, entity-to-group affiliations, entity-to-individual affiliations, attributes from the organization's profile of the entity, and a combination thereof.

11. The method of claim 1, wherein the passive delivery of time sensitive scheduling data includes deriving interest for targeting a receiving entity based on the entity's filtering of time sensitive scheduling data, the entity's selection of promotional content accompanying the display of time sensitive scheduling data, the entity's tagging certain time sensitive scheduling data items for reminder notices of upcoming activities and observances, the entity's reservations notices for upcoming activities, the entity's need to know, and the entity's affinity groups.

12. A system for communications network based passive delivery of relevant and desired promotional content and time sensitive scheduling data via a communication technology via a time sensitive scheduling data receiving device to an entity, the system comprising:
a time sensitive scheduling data center for storing time sensitive scheduling data, collecting time sensitive scheduling data from an entity, and sending promotional content and time sensitive scheduling data to the entity upon the entity being authenticated and validated;
connectivity medium communication interfaces for transmitting authentication, validation information, promotional content, and time sensitive scheduling data between the time sensitive scheduling data center, a communication technology, and a time sensitive scheduling data receiving device;
a communication technology suitable for receiving and sending the passive delivery of promotional content and time sensitive scheduling data;
processors for processing executable instructions for:
targeting promotional content based on targeting criteria;
distributing via a passive delivery communications network promotional content based on the targeting criteria;
delivering via the passive delivery communications network promotional content aggregated as part of time sensitive scheduling data streams;
presenting passive delivery of promotional content in proximity to relevant time sensitive scheduling data to the entity via a time sensitive scheduling data receiving device; and
a time sensitive scheduling data receiving device for receiving and sending authentication, validation information, promotional content, and time sensitive scheduling data to the time sensitive scheduling data center via the connectivity medium communication interfaces via the communication technology.

13. The system of claim 12, wherein the targeting criteria is affiliations between targeted entities.

14. The system of claim 12, wherein the targeting criteria is an entity's activities.

15. The system of claim 12, wherein the targeting criteria is an entity's derived and designated interest in specific categories of the time sensitive scheduling data.

16. The system of claim 12, wherein the targeting criteria is an entity's request for specific time sensitive scheduling data.

17. The system of claim 12, wherein the targeting criteria is an entity's affiliation profile.

18. The system of claim 12, wherein the time sensitive scheduling data consists of data relating to a class of entity activities originating from a class of time sensitive scheduling data activity sources.

19. The system of claim 18, wherein the class of entity activities is selected from the group consisting of attending, timely participating, scheduling, planning, organizing, timely responding, reserving, and a combination thereof.

20. The system of claim 18, wherein the class of time sensitive scheduling data activity sources is selected from the group consisting of standard events, standard meetings, ad hoc activities, observances, and a combination thereof.

21. The system of claim 12, wherein the passive delivery of time sensitive scheduling data includes deriving interest for targeting a receiving entity based on information from provider organization's membership rolls and affiliation rolls as they pertain to entity items selected from the group consisting of entity-to-organization affiliations, entity-to-group affiliations, entity-to-individual affiliations, attributes from the organization's profile of the entity, and a combination thereof.

22. The system of claim 12, wherein the passive delivery of time sensitive scheduling data includes deriving interest for targeting a receiving entity based on the entity's filtering of time sensitive scheduling data, the entity's selection of promotional content accompanying the display of time sensitive scheduling data, the entity's tagging certain time sensitive scheduling data items for reminder notices of upcoming activities and observances, the entity's reservations notices for upcoming activities, the entity's need to know, and the entity's affinity groups.

23. A receiving device suitable for providing the communications network based passive delivery of relevant and desired promotional content and time sensitive scheduling data to an entity, comprising:
a display for displaying a message in accordance with promotional content and time sensitive scheduling data;
a time sensitive scheduling data communication interface arranged to send and receive signals from servers of a time sensitive scheduling data network;
a processor for processing executable authentication and validation instructions; and
a controller in communication with the processor and the time sensitive scheduling data communication interface arranged to send and receive signals from the servers of the time sensitive scheduling data network to determine if a time sensitive scheduling data receiving entity is authenticated and validated to receive promotional content and time sensitive scheduling data from a server wherein when the controller determines that the time sensitive scheduling data receiving entity is authenticated and validated to receive promotional content and time sensitive scheduling data from the server, then the processor notifies the server to send promotional content and time sensitive scheduling data to the receiving entity via the time sensitive scheduling data communication interface.

24. A computer program product executable by a computer processor for processing the passive delivery of relevant and desired promotional content and time sensitive scheduling data generated via a communications network to an entity, comprising:
computer code for targeting promotional content based on targeting criteria;
computer code for distributing via a passive delivery communications network promotional content based on the targeting criteria;
computer code for delivering via the passive delivery communications network promotional content aggregated as part of time sensitive scheduling data streams;
computer code for presenting passive delivery of promotional content in proximity to relevant time sensitive scheduling data to the entity via a time sensitive scheduling data receiving device; and
computer readable medium for storing the computer code.

25. The computer program product of claim 24, wherein the targeting criteria is affiliations between targeted entities.

26. The computer program product of claim 24, wherein the targeting criteria is an entity's activities.

27. The computer program product of claim 24, wherein the targeting criteria is an entity's derived and designated interest in specific categories of time sensitive scheduling data.

28. The computer program product of claim 24, wherein the targeting criteria is an entity's request for specific time sensitive scheduling data.

29. The computer program product of claim 24, wherein the targeting criteria is an entity's affiliation profile.

30. The computer program product of claim 24, wherein the time sensitive scheduling data consists of data relating to a class of entity activities originating from a class of time sensitive scheduling data activity sources.

31. The computer program product of claim 30, wherein the class of entity activities is selected from the group consisting of attending, timely participating, scheduling, planning, organizing, timely responding, reserving, and a combination thereof.

32. The computer program product of claim 30, wherein the class of time sensitive scheduling data activity sources is selected from the group consisting of standard events, standard meetings, ad hoc activities, observances, and a combination thereof.

33. The computer program product of claim 24, wherein the passive delivery of time sensitive scheduling data includes deriving interest for targeting a receiving entity based on information from provider organization's membership rolls and affiliation rolls as they pertain to entity items selected from the group consisting of entity-to-organization affiliations, entity-to-group affiliations, entity-to-individual affiliations, attributes from the organization's profile of the entity, and a combination thereof.

34. The computer program product of claim 24, wherein the passive delivery of time sensitive scheduling data includes deriving interest for targeting a receiving entity based on the entity's filtering of time sensitive scheduling data, the entity's selection of promotional content accompanying the display of time sensitive scheduling data, the entity's tagging certain time sensitive scheduling data items for reminder notices of upcoming activities and observances, the entity's reservations notices for upcoming activities, the entity's need to know, and the entity's affinity groups.

35. A system for simultaneous passive delivery of relevant and desired promotional content and time sensitive scheduling data via multiple communication technologies via an array of multiple communication time sensitive scheduling data receiving devices to an entity, the system comprising:
a time sensitive scheduling data center for storing time sensitive scheduling data, collecting time sensitive scheduling data from an entity, and sending promotional content and time sensitive scheduling data to the entity upon the entity being authenticated and validated;
connectivity medium communication interfaces for transmitting authentication, validation information, promotional content, and time sensitive scheduling data between the time sensitive scheduling data center, multiple communication technologies, and multiple communication time sensitive scheduling data receiving devices;
multiple communication technologies suitable for receiving and sending the passive delivery of promotional content and time sensitive scheduling data;
processors for processing executable instructions; and
multiple communication time sensitive scheduling data receiving devices for receiving and sending authentication, validation information, promotional content, and time sensitive scheduling data to the time sensitive scheduling data center via the connectivity medium communication interfaces via multiple communication technologies.

36. An activity content delivery system, comprising:
a system authorization process device performing entity validation checks and verification functions for requesting a entity's subscriber profile;
a retrieve subscriber's profile process device extracting the entity's subscriber profile from a subscription profile database;
a content fulfillment process device using information from the entity's subscribers profile to generate an activity retrieval request in the form of activity extraction criteria and a promotional content matching criteria from an affiliation profile criteria;
an activity request process device extracting matching activity content from an activity content database;
a promotional matching process device generating a promotion matching criteria by adding contextual information to the promotional content retrieval request;
a promotional content retrieval process device extracting matching promotional content from a promotional content table;
a content packaging process device generating bundles of content from processes involved in the matching promotional content fulfillment process;
a data store; and
time sensitive scheduling data receiving devices.

37. The system of claim 36, wherein the affiliation profile criteria is selected from the group consisting of an entity's affiliations, affinity groups, areas of interest for activities, areas of interest for associations, and a combination thereof.

38. The system of claim 36, wherein the contextual information is selected from the group consisting of time of day, entity language requirements, and entity location.

39. The system of claim 36, wherein the bundles of content is selected from the group consisting of activity content, matching promotional content, and administrative messages

40. A system for the passive delivery of aggregated promotional content and personal time sensitive scheduling data from multiple sources, the system comprising:
promotional content and specific personal time sensitive scheduling data aggregated from multiple originating organizations, affiliated groups of individuals, and individuals to an entity based on desirability and relevancy of high utility time sensitive scheduling data;
aggregated promotional content and specific personal time sensitive scheduling data streams transmitting to the entity based on the promotional content and the time sensitive scheduling data having desirability and relevancy of high utility; and
promotional content and specific personal time sensitive scheduling data delivered to a time sensitive scheduling data receiving device.
